(19) United States
(12) Patent Application Publication
(10) Pub. No.: US 2017/0237267 A1
(43) Pub. Date: Aug. 17, 2017

(54) WIRELESS POWER RECEIVING ELEMENT WITH CAPACITIVE COUPLING

(71) Applicant: QUALCOMM Incorporated, San Diego, CA (US)

(72) Inventors: Edward Kenneth KALLAL, San Diego, CA (US); David FERN, Santee, CA (US)

(21) Appl. No.: 15/042,168

(22) Filed: Feb. 12, 2016

(51) Int. Cl. H02J 5/00; H02J 50/12; H04B 1/3827

(52) U.S. Cl. CPC H02J 5/005; H04B 1/385; H02J 50/12

(57) ABSTRACT

A wireless power receiving element with capacitive coupling is described herein. The design allows for a wireless power receiving element that extends all the way around the band of a wearable electronic device. In an area where one end of the band clasps to the other, a capacitive coupling is provided, allowing the element to extend around the entire band without requiring a direct physical connection to complete this circuit.

### TECHNICAL FIELD

The described technology generally relates to wireless power. More specifically, the disclosure is directed to devices, systems, and methods related to the receiving of wireless power by an electronic device with capacitive coupling.

### BACKGROUND

In wireless power applications, wireless power charging systems may provide the ability to charge and/or power electronic devices without physical, electrical connections, thus reducing the number of components required for operation of the electronic devices and simplifying the use of the electronic device. Such wireless power charging systems may comprise a power transmitting element and other transmitting circuitry configured to generate a magnetic field that may induce a current in a power receiving element that may be connected to the electronic device to be charged or powered wirelessly. Similarly, the electronic devices may comprise a power receiving element and other receiving circuitry configured to generate a current when exposed to a magnetic field.

Electronic devices may include a number of wearable devices, such as smart watches and fitness tracking devices. In both of these applications, having a power receiving element around the device's wristband may be advantageous for wireless power transfer. Consequently, it may be advantageous to provide for such a power receiving element while reducing the mechanical complexity of the product.

### SUMMARY

The implementations disclosed herein each have several innovative aspects, no single one of which is solely responsible for the desirable attributes of the invention. Without limiting the scope, as expressed by the claims that follow, the more prominent features will be briefly disclosed here. After considering this discussion, one will understand how the features of the various implementations provide several advantages over current power receiving elements used in devices which can be charged wirelessly.

In one set of aspects, an electronic device configured to wirelessly receive power using a power receiving element is disclosed. The device includes a body including a portion of the power receiving element. The device further includes a first band portion connected to the body. The first band portion includes a first conductive plate. The first conductive plate is electrically connected to the portion of the power receiving element via a first conductor extending along the first band portion. The device further includes a second band portion connected to the body. The second band portion includes a second conductive plate. The second conductive plate is electrically connected to the portion of the power receiving element via a second conductor extending along the second band portion. The second band portion is configured to be selectively attached to or detached from the first band portion. The second conductive plate is configured to form a parallel plate capacitor with the first conductive plate when the second band portion is attached to the first band portion.

In some aspects, the first conductive plate is positioned on the first band portion substantially distal to a first point where the first band portion is connected to the body and the second conductive plate is positioned substantially distal to a second point where the second band portion is connected to the body. The power receiving element may forms a winding extending substantially around the body and the first conductor and the second conductor, a path for electrical current provided through the winding and the parallel plate capacitor. In aspects, the power receiving element includes an electrical resonant circuit including the parallel plate capacitor. The resonant circuit is tuned to resonate at a particular frequency, the frequency corresponding to a frequency of an externally generated alternating magnetic field. In some aspects, one or more of the first conductive plate and the second conductive plate may include a copper plate or a copper alloy plate. The electronic device may be one of a watch or a fitness tracking device. The first conductive plate and the second conductive plate may have a width between 20 mm and 50 mm. The first conductive plate and the second conductive plate may have a length between 10 mm and 35 mm. The parallel plate capacitor formed by the first conductive plate and the second conductive plate may be a series capacitor in the power receiving circuit. When the second band is attached to the first band, the first conductive plate and the second conductive plate may be separated by a dielectric material, which may be rubber. When the second band is attached to the first band, the first conductive plate and the second conductive plate may be separated by between 0.05 mm and 0.3 mm.

In some aspects, an electronic device is disclosed, which includes a first electrical connector disposed in a distal portion of a first band portion on the electronic device. The device further includes a second electrical connector disposed in a distal portion of a second band portion on the electronic device, the first band portion and the second band portion configured to be selectively attached to or detached from one another. The device also includes a power receiving element which extends from the first electrical connector through the first band portion and the second band portion to the second electrical connector, wherein the first electrical connector and the second electrical connector are configured to be in electrical connection with each other when the first band portion and the second band portion are attached to one another, the power receiving element configured to wirelessly receive power from another device.

In some aspects, the electronic device may be one of a watch or a fitness tracking device. The first electrical connector and the second electrical connector may be inductors, and the electrical connection may be an inductive connection. The first electrical connector and the second electrical connector may be capacitive plates, and the electrical connection may be a capacitive connection. One or more of the first electrical connector and the second electrical connector may include a copper plate or a copper alloy plate. The first electrical connector and the second electrical connector may have a width between 20 mm and 50 mm. The first electrical connector and the second electrical connector may have a length between 10 mm and 35 mm. When the second band portion is attached to the first band portion, the first electrical connector and the second electrical connector may be separated by a dielectric material, which may be rubber. When the second band portion is attached to the first band portion, the first electrical connector and the second electrical connector may be separated by between 0.05 mm and 0.3 mm.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations, however, are merely examples and are not intended to be limiting. Throughout the drawings, similar symbols typically identify similar components, unless context dictates otherwise. Note that the relative dimensions of the following figures may not be drawn to scale.

FIG. 1 is a functional block diagram of a wireless power transfer system, in accordance with an illustrative embodiment.

FIG. 2 is a functional block diagram of a wireless power transfer system, in accordance with another illustrative embodiment.

FIG. 3 is a schematic diagram of a portion of the transmit circuitry or the receive circuitry of FIG. 2, in accordance with illustrative embodiments.

FIG. 4 is an illustration of possible positions for conductive plates on an exemplary wearable device.

FIG. 5 is an exemplary series tuned circuit that represents a wireless power receiving element in a simplified form.

FIG. 6 is another exemplary series tuned circuit that represents a wireless power receiving element in a simplified form.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured by, or coupled by a “power receiving element” to achieve power transfer.

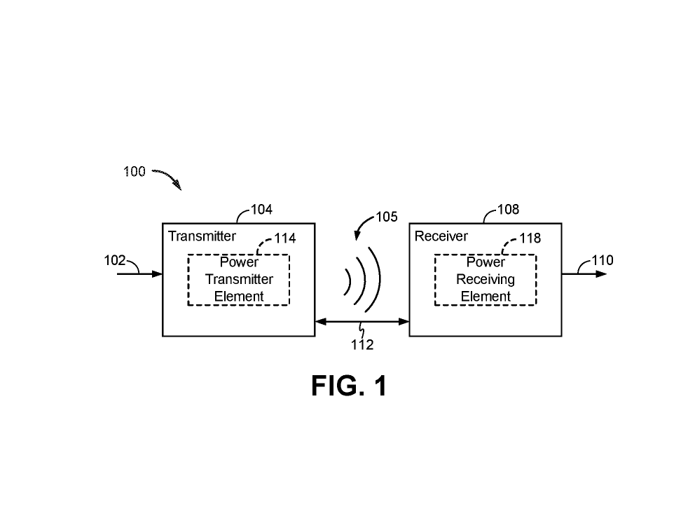

FIG. 1 is a functional block diagram of a wireless power transfer system 100, in accordance with an illustrative embodiment. Input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate output power 110 for storing or consumption by a device (not shown in this figure) coupled to the output power 110. The transmitter 104 and the receiver 108 may be separated by a distance 112. The transmitter 104 may include a power transmitting element 114 for transmitting/coupling energy to the receiver 108. The receiver 108 may include a power receiving element 118 for receiving or capturing/coupling energy transmitted from the transmitter 104.

In one illustrative embodiment, the transmitter 104 and the receiver 108 may be configured according to a mutual resonant relationship. When the resonant frequency of the receiver 108 and the resonant frequency of the transmitter 104 are substantially the same or very close, transmission losses between the transmitter 104 and the receiver 108 are reduced. As such, wireless power transfer may be provided over larger distances. Resonant inductive coupling techniques may thus allow for improved efficiency and power transfer over various distances and with a variety of inductive power transmitting and receiving element configurations.

In certain embodiments, the wireless field 105 may correspond to the “near field” of the transmitter 104 as will be further described below. The near field may correspond to a region in which there are strong reactive fields resulting from the currents and charges in the power transmitting element 114 that minimally radiate power away from the power transmitting element 114. The near field may correspond to a region that is within about one wavelength (or a fraction thereof) of the power transmitting element 114.

In certain embodiments, efficient energy transfer may occur by coupling a large portion of the energy in the wireless field 105 to the power receiving element 118 rather than propagating most of the energy in an electromagnetic wave to the far field.

In certain implementations, the transmitter 104 may output a time varying magnetic (or electromagnetic) field with a frequency corresponding to the resonant frequency of the power transmitting element 114. When the receiver 108 is within the wireless field 105, the time varying magnetic (or electromagnetic) field may induce a current in the power receiving element 118. As described above, if the power receiving element 118 is configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge or to power a load.

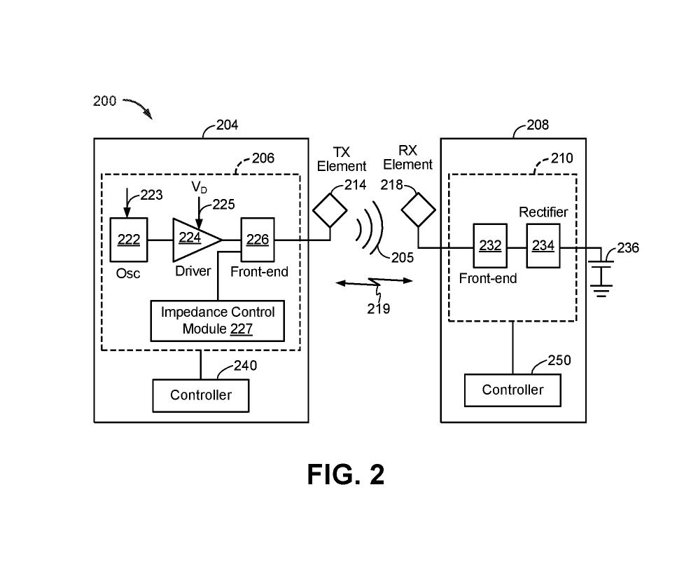

FIG. 2 is a functional block diagram of a wireless power transfer system 200, in accordance with another illustrative embodiment. The system 200 may include a transmitter 204 and a receiver 208. The transmitter 204 (also referred to herein as a power transmitting unit, PTU) may include transmit circuitry 206 that may include an oscillator 222, a driver circuit 224, a front-end circuit 226, and an impedance control module 227. The oscillator 222 may be configured to generate a signal at a desired frequency that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output a sine wave.

The front-end circuit 226 may include a filter circuit (not shown) to filter out harmonics or other unwanted frequencies. The front-end circuit 226 may include a matching circuit (not shown) to match the impedance of the transmitter 204 to the power transmitting element 214. As will be explained in more detail below, the front-end circuit 226 may include a tuning circuit (not shown) to create a resonant circuit with the power transmitting element 214. As a result of driving the power transmitting element 214, the power transmitting element 214 may generate a wireless field 205 to wirelessly output power at a level sufficient for charging a battery 236, or otherwise powering a load. The impedance control module 227 may control the front-end circuit 226.

The transmitter 204 may further include a controller 240 operably coupled to the transmit circuitry 206 configured to control one or aspects of the transmit circuitry 206 or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by it. The transmitter 204 may further include a memory (not shown) configured to store data, for example, such as instructions for causing the controller 240 to perform particular functions, such as those related to management of wireless power transfer.

The receiver 208 (also referred to herein as power receiving unit, PRU) may include receive circuitry 210 that may include a front-end circuit 232 and a rectifier circuit 234. The front-end circuit 232 may include matching circuitry (not shown) to match the impedance of the receive circuitry 210 to the power receiving element 218. As will be explained below, the front-end circuit 232 may further include a tuning circuit (not shown) to create a resonant circuit with the power receiving element 218. The rectifier circuit 234 may generate a DC power output from an AC power input to charge the battery 236, as shown in FIG. 2. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. The transmitter 204 may be configured to generate a predominantly non-radiative field with a direct field coupling coefficient for providing energy transfer. The receiver 208 may directly couple to the wireless field 205 and may generate an output power for storing or consumption by a battery 236 (or other load) coupled to the output of the receive circuitry 210.

The receiver 208 may further include a controller 250 configured similarly to the transmit controller 240 as described above for managing one or more aspects of the receiver 208. The receiver 208 may further include a memory (not shown) configured to store data, for example, such as instructions for causing the controller 250 to perform particular functions, such as those related to management of wireless power transfer.

As discussed above, transmitter 204 and receiver 208 may be separated by a distance and may be configured according to a mutual resonant relationship to minimize transmission losses between the transmitter and the receiver.

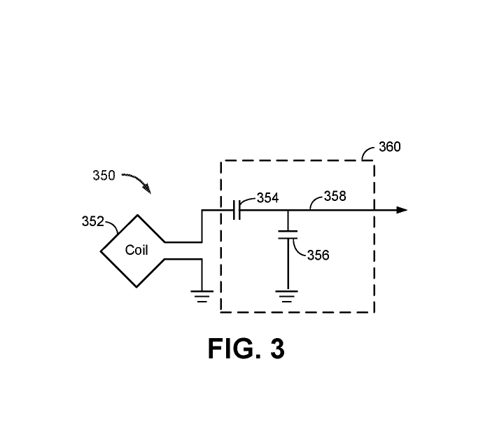

FIG. 3 is a schematic diagram of a portion of the transmit circuitry 206 or the receive circuitry 210 of FIG. 2, in accordance with illustrative embodiments. As illustrated in FIG. 3, transmit or receive circuitry 350 may include a power transmitting or receiving element 352 and a tuning circuit 360. The power transmitting or receiving element 352 may also be referred to, or be configured as, an antenna or a “loop” antenna. The term “antenna” generally refers to a component that may wirelessly output or receive energy for coupling to another “antenna.” The power transmitting or receiving element 352 may also be referred to herein or be configured as a “magnetic” antenna, or an induction coil, a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown in this figure).

When the power transmitting or receiving element 352 is configured as a resonant circuit or resonator with tuning circuit 360, the resonant frequency of the power transmitting or receiving element 352 may be based on its inductance and capacitance. Inductance may be simply the inductance created by a coil or other inductor forming the power transmitting or receiving element 352. Capacitance (e.g., a capacitor) may be provided by the tuning circuit 360 to create a resonant structure at a desired resonant frequency. As a non-limiting example, the tuning circuit 360 may comprise a capacitor 354 and a capacitor 356 may be added to the transmit or receive circuitry 350 to create a resonant circuit.

The tuning circuit 360 may include other components to form a resonant circuit with the power transmitting or receiving element 352. As another non-limiting example, the tuning circuit 360 may include a capacitor (not shown) placed in parallel between the two terminals of the transmit or receive circuitry 350. Still other designs are possible. In some embodiments, the tuning circuit in the front-end circuit 226 (of FIG. 2) may have the same design (e.g., tuning circuit 360) as the tuning circuit in front-end circuit 232 (of FIG. 2). In other embodiments, the front-end circuit 226 may use a tuning circuit design different than that of the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352.

Wireless power transfer may be useful in various types of electronic devices. Users may find wireless charging of devices much more convenient than traditional wired charging methods, as it may be more convenient to charge a devices wirelessly rather than having to plug the device in to charge it. As new devices with new form factors develop, wireless charging may also need to develop in order to best accommodate these new form factors. For example, one new and unique form factor in which wireless transfer may be used is for wearable devices such as devices which wrap around a user's wrist/arm or ankle/leg. For example, this may include smart watches and fitness or activity tracking devices, which may both have wrist bands that wrap around a user's wrist. In both of these types of devices, as well as other possible devices, creating a power receiving element around the device's wristband may be advantageous, as generally having a power receiving element with a larger area may be advantageous. However, such a power receiving element may add mechanical complexity to the device.

Generally, a power receiving element which extends around the circumference of the wristband of the device may offer several advantages. Such a power receiving element may include portions which are inside a body of the device, and may also extend through both sides of the body, and all the way around the circumference of the wrist band. One advantage of a larger power receiving element is that available power transfer may be proportional to the surface area of a power receiving element, such that a larger power receiving element may allow for a higher available power transfer, which may allow a device to charge more quickly than other power receiving element configurations. Further, as an area of the power receiving element increases, the range of voltages seen by the power receiving element may decrease. This may allow for a simpler circuit to be needed in order to accommodate the smaller range of voltages.

Thus, increasing surface area of the power receiving element, such as forming a power receiving element around the circumference of the wristband of the device may allow for better power transfer, transferring more power more efficiently and in less time. In such a wearable device, the largest possible power receiving element is to wrap the element around the wristband of the device. Accordingly, such a configuration may be desired as it may increase available power transfer and reduce the complexity of the receiving circuit by reducing the voltage ranges.

For comparison, an alternative design may be to include a power receiving element that is in only one part of the device. A power receiving element may be found in the back of a watch body, for example, rather than around the circumference of the wristband. Such an implementation may include a much smaller coil, which may reduce the power available and may expand the voltage ranges, as described above. Further, meeting commercial form factor (thickness) requirements with such a watch body power receiving element may require adding ferrite to shield the power receiving element coil from the metal in the watch electronics. This may add further cost and complexity.

However, while a power receiving element that covered the circumference of the wrist bands on a device offers electrical benefits, the design may be more complex mechanically. Generally, the wrist bands of a wearable device may removably attach from each other, in order to allow a user to put the device on and to take the device off. Forming a power receiving element that is electrically connected to form a continuous loop across such a detachable connection between the bands may be difficult, or may add significant mechanical complexity and cost to the manufacture of such a device. A design of such a power receiving element may be made such that the wrist band can open when the user wishes to remove the device from their wrist, and enables electrical contact between the two ends of the wristband in order for the power receiving element to operate.

Accordingly, it may be desirable, in some aspects, to provide a design of a power receiving element that does not require a physical electrical connection between the two ends of the wrist band, while still allowing the power receiving element to use the full area of the wrist band. For example, a power receiving element may form a capacitor across the portion of the bands which attach together. In some aspects, a power receiving circuit may also include an inductive connection between the two bands of the device.

As described above, the power receiving element may be configured as a resonant circuit, and may have a resonant frequency based on the inductance and the capacitance of the circuit. In such a circuit, adjusting the impedance on an additional receiving winding can adjust the reactance created by the receiver and the receiver's rectified output voltage.

One way to allow the power receiving element to use the full area of the wristband may be to provide for the two ends of the wristband to form a parallel capacitor. In some aspects, each end of the power receiving element may terminate at a conductive plate, such as a copper plate. In some aspects, the two plates may be planes on a flex printed circuit board (PCB) near the edge of the wristband. These conductive plates may each be placed at an end of the wristband, such that when the wristband is closed (such as around a user's wrist or on a charging device), the two conductive plates form a parallel capacitor. In such a configuration, a user may clamp the two ends of the wristband together in order to place the device onto a power transmitting element, such as on a wireless battery charger.

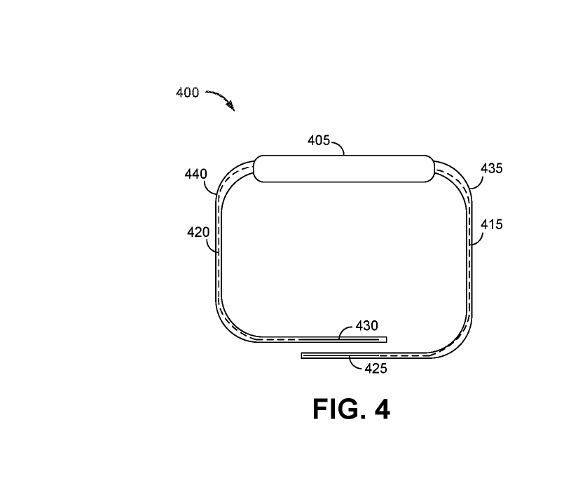

FIG. 4 is an illustration of possible positions for conductive plates on an example wearable device 400. Wearable device 400 may include a casing or a body 405, which may include various components, including parts of the power receiving circuit. For example, the body 405 may include portions of the power receiving circuit as well as other components, such as watch components if wearable device 400 takes the form of a watch. In some aspects, the body 405 may be larger or smaller than illustrated. For example, in certain fitness tracking devices, the body 405 may be sized similarly to the bands of the device itself, and may be far less prominent than illustrated here. The body 405 may, for example, be of similar thickness to the bands of the device 400.

Wearable device 400 may further include a first band 435. The first band 435 may extend outward from the body 405 of the device 400 on one side of the body 405. The first band 435 may be constructed of a flexible or semi-flexible material, and/or may be curved in order to allow the first band 435 to wrap around a limb of a user, such as the user's wrist, arm, or leg. Wearable device 400 may further include a second band 440. The second band 440 may extend outwardly from the body 405 of the device 400. For example, the second band 440 may extend from a portion of the body 405 that is opposite the portion to which the first band 435 is attached. Like the first band 435, the second band 440 may be constructed of a flexible or semi-flexible material, and/or may be curved in order to allow the second band 440 to wrap around a limb of a user, such as the user's wrist, arm, or leg. The first band 435 and the second band 440 may thus be arranged in order to allow the device to be placed on a user's limb. The bands 435, 440 may include a mechanism by which the bands 435, 440 may be removably attached to each other (e.g., attached to or detached from each other) in order to secure the device onto a user's limb. For example, the bands 435, 440 may use clasps, magnets, notches in the bands, or other mechanisms to close the bands 435, 440 around a user's limb.

The power receiving circuit may also include a first electrical connection 415 or first conductor (e.g., a winding portion) that extends through the first band 435 of wearable device 400, and which terminates at conductive plate 425. The conductive plate 425 may be at a point distal to the portion of the first band 435 that connects to the device body (e.g., located at or near the end of the first band 435). The power receiving circuit further includes a second electrical connection 420 or conductor (e.g., a winding portion) that extends through the second band 440 of the wristband of wearable device 400, and which terminates at conductive plate 430. The conductive plate 430 may be at a point distal to the portion of the second band 440 that connects to the device body 405 (e.g., located at or near the end of the second band 440). The conductive plates 425, 430 may be made out of any conductive material, such as copper. The conductive plates 425, 430 may be positioned such that when the two bands 435, 440 of the device 400 are removably attached to one another (e.g., attached to or detached from one another), such as being clamped together or closed in another manner, the two conductive plates 425, 430 will form a parallel plate capacitor. This parallel plate capacitor may be in series with other portions of the power receiving element, which may stretch from the first conductive plate 425, through the first electrical connection 415 in the first band 435, through the body 405, through the second electrical connection 420 in the second band 440, and finally terminating at the second conductive plate 430.

Each of the two conductive plates 425, 430 may be coated with a material that may act as a dielectric material. For example, this material may protect the plate from the elements, and may cover or partially cover the conductive plates 425, 430. When the bands 435, 440 are clasped together, the conductive plates 425, 430 may be separated from each other by the dielectric material. This material may be a non-conductive material, such as rubber. When the conductive plates 425, 430 form a parallel plate capacitor, this material may act as a dielectric in the parallel plate capacitor, and may serve to keep the plates 425, 430 separated by a known distance from one another.

In practice, it may be beneficial to maximize the amount of capacitance available within the constraints of the form factor in order to minimize the reactance of the capacitance network, such as the side of a wristband on a wearable device. The reactance of a capacitive network may be given by the formula:

$${X}_{c} = \frac{1}{j ⋆ ω ⋆ C} \qquad ( 1 )$$

where X_{c} is the capacitive reactance of the network, j is the square root of −1, ω is an angular frequency of the signal, and C is the capacitance in the network. Thus, maximizing the capacitance of the network minimizes the reactance of the capacitive network. Here, zero reactance would represent a low-inductance electrical contact. Based on previous power receiving element designs, it may be desirable to provide less than j200 ohms of reactance.

The capacitance of a parallel plate capacitor is given by the formula:

$$C = \frac{k ⋆ ɛ ⋆ A}{d} \qquad ( 2 )$$

where C is the capacitance of the capacitor, k is the relative permittivity of a dielectric material between the plates, ε is the permittivity of space, A is the area of the plates, and d is the distance between the plates. For example, if the capacitive plates are 20 mm by 35 mm, this may result in 217 pF capacitance (−j108 ohms of reactance). This size may be realistic for a band 35 mm wide, where the plates overlap for 20 mm at the end of the two bands, where there is a 0.2 mm separation between the two plates, and where the dielectric constant is 7 (for rubber). Other values may also be used, but these exemplary values may be realistic for some implementations of such a device.

Accordingly, in some aspects, the bands, or straps, of a device may include conductive plates. These conductive plates may be made of any conductive material, including copper and copper alloys. The conductive plates may be any width, such as being 5, 10, 20, 35, 50, or 75 mm wide. The width of the conductive plates may be based, at least in part, on a width of the band of the device and based on the desired capacitance of the capacitor. For example, the width of the plate may be between 20 and 50 mm. The conductive plates may be any length, such as being 5, 10, 20, 35, 50, or 75 mm wide. The length of the conductive plates may be based, at least in part, on an amount of overlap between the bands of the device when the bands are closed together (via clasping or other mechanism) and based on the desired capacitance of the capacitor. For example, the length of the plate may be between 10 and 35 mm.

In some aspects, each of the conductive plates may be covered in a dielectric material, at least partially. This material may separate the plates from one another when the bands are closed together, and may also prevent damage to the plates from ordinary wear and tear as the device is worn and used. In some aspects, this material may form a dielectric material when the bands of the device are closed to form a parallel plate capacitor. For example, the material may be a non-conductive material. In some aspects, the non-conductive material may be rubber. The material may have a dielectric constant under approximately ten, such as rubber which has a dielectric constant of approximately 7. In some aspects, the material may be configured such that the conductive plates are separated by any distance, such as 0.05, 0.1, 0.15, 0.2, 0.3, or 0.5 mm when the bands are closed together. Other distances may also be used. For example, the plates of the parallel plate capacitor may be separated by between 0.05 mm and 0.3 mm. In some aspects, the material used as a dielectric and the distances between the conductive plates may be chosen based, at least in part, on a desired capacitance of the parallel plate capacitor formed by the conductive plates.

Electrically, placing capacitors in the configuration described herein may be similar to placing tuning capacitors in the middle of a center-tapped coil but with added advantages. By integrating the capacitance in series with the coil, this reduces the amount of tuning required from the normal tuning capacitors. Since this design does not require as much reactance shift from the tuning capacitors, lower voltage capacitors can be used to reduce component area. The capacitance may be selected or combined with other tuning capacitors such that the inductance of the winding and total capacitance form a resonant circuit that is configured to resonate at a particular frequency, such as the frequency of an externally generated magnetic field (e.g., the field generated by a transmitter 204 (FIG. 2).

In another aspect, the device 400 may be adjustable such that the first and second bands 435, 440 are clasped together at multiple points to allow adjusting the circumference of the band to fit different sized wrists or limbs. In this situation, the overlap between the first and second conductive plates 425, 430 may be variable and therefore the capacitance may change based on the position of the two plates. In this case, tuning circuitry, e.g., front-end circuit 232, may include variable capacitance elements (e.g., variable capacitors or banks of switchable capacitors) that are configured to tune the resonant circuit in response to different positions of the first and second conductive plates 425, 430. However, in some implementations, there may be a default configuration for charging for how the first and second bands 435, 440 are clasped to provide a constant capacitance.

In some aspects, the coils may be integrated in the end of the strap, allowing inductive coupling between the two straps of the wristband. For example, rather than each end of the strap having a conductive plate, each end of the strap may instead have a coil. When the straps of the device are closed, such as being clasped together, the coils at each end may be inductively coupled to one another. This may allow a power receiving element to span between the two ends of the strap without requiring a physical electrical connection between the two ends of the strap.

Generally, the voltage at the output of a wireless power receiving element is desirably kept in as narrow of a range as practical, as a narrower range makes the DC to DC converter used in the wireless power receiving element more compact and less costly. Such a DC to DC converter may be needed in order to provide the load in the circuit, such as a battery, with the proper voltage to charge. The induced voltage in the receive coupler coil is a function of the mutual inductance of the coil times the transmitter current. A pure series resonant filter delivers a voltage to the input of the rectifier that is close as possible to the induced voltage.

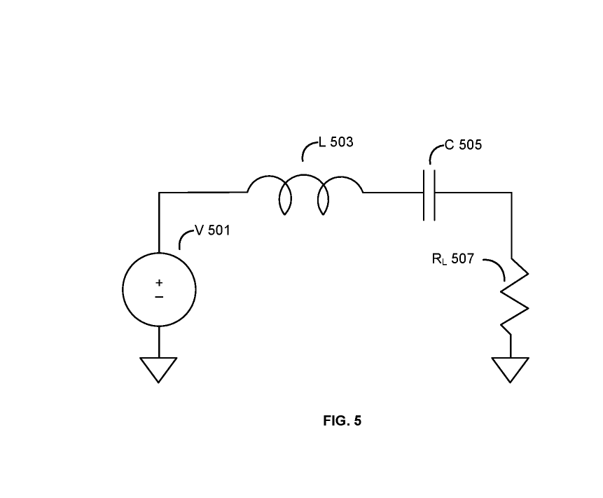

FIG. 5 represents an exemplary series tuned circuit that represents a wireless power receiving element in a simplified form. The voltage source V 501 corresponds to the receive coupler coil, where the value of V is equal to w (number of coil windings) times M (mutual inductance) times Itx (transmitter coil current).

The element L 503 represents the total inductance of the wireless power receiving element, which may include one or more inductors. The element C 505 represents a capacitance of the wireless power receiving element. The value of capacitance C 505 may be chosen to have equal and opposite reactance to L 503 at a relevant frequency band. R_{L} 507 represents the load on the power receiving element. In some aspects, the capacitance C 505 may be contained in one or more capacitors. According to some aspects of the present disclosure, capacitance C 505 may include a capacitor that is formed between two conductive plates positioned as illustrated in FIG. 4.

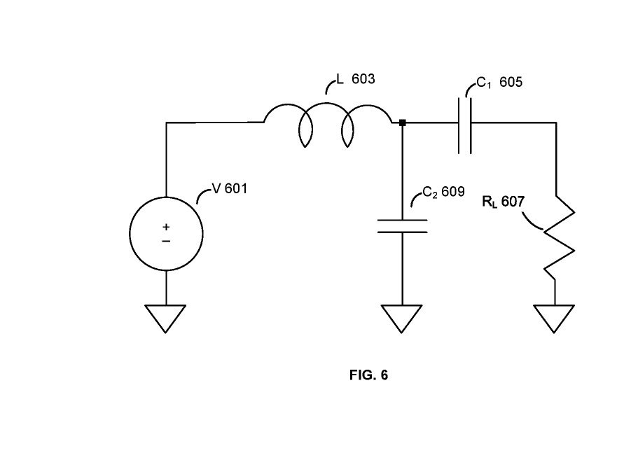

In some aspects, a power receiving element may also include shunt tuning. FIG. 6 shows a wireless power receiving element, with elements similar to those of FIG. 5 which are similarly numbered (V 601, L 603, C₁ 605, R_{L} 607), and where shunt tuning is represented by C₂ 609. Here, the capacitance C₁ 605 may include the parallel plate capacitor formed by the first conductive plate and the second conductive plate, as illustrated in FIG. 4.

The various operations of methods performed by the apparatus or system described above may be performed by any suitable means capable of performing the operations, such as various hardware and/or software component(s), circuits, and/or module(s). Generally, any operations or components illustrated in the Figures may be performed or replaced by corresponding functional means capable of performing the operations of the illustrated components.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions may not be interpreted as causing a departure from the scope of the implementations presented here.

The various illustrative blocks, modules, and circuits described in connection with the implementations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the implementations disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor may read information from, and write information to, the storage medium. In the alternative, the storage medium may be integral to the processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above may also be included within the scope of computer readable media. The processor and the storage medium may reside in an ASIC.

For purposes of summarizing the disclosure, certain aspects, advantages and novel features have been described herein. It is to be understood that not necessarily all such advantages may be achieved in accordance with any particular implementation. Thus, the various aspects described here may be embodied or carried out in a manner that achieves or optimizes one advantage or group of advantages as taught herein without necessarily achieving other advantages as may be taught or suggested herein.

Various modifications of the above described implementations will be readily apparent, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. An electronic device configured to wirelessly receive power using a power receiving element, the device comprising:
a body including a portion of the power receiving element;
a first band portion connected to the body, the first band portion including a first conductive plate, the first conductive plate electrically connected to the portion of the power receiving element via a first conductor extending along the first band portion; and
a second band portion connected to the body, the second band portion including a second conductive plate, the second conductive plate electrically connected to the portion of the power receiving element via a second conductor extending along the second band portion, the second band portion configured to be selectively attached to or detached from the first band portion, the second conductive plate configured to form a parallel plate capacitor with the first conductive plate when the second band portion is attached to the first band portion.

2. The device of claim 1, wherein the first conductive plate is positioned on the first band portion substantially distal to a first point where the first band portion is connected to the body, wherein the second conductive plate is positioned substantially distal to a second point where the second band portion is connected to the body.

3. The device of claim 1, wherein the power receiving element forms a winding extending substantially around the body and the first conductor and the second conductor, a path for electrical current provided through the winding and the parallel plate capacitor.

4. The device of claim 1, wherein the power receiving element comprises an electrical resonant circuit comprising the parallel plate capacitor.

5. The device of claim 4, wherein the resonant circuit is tuned to resonate at a particular frequency, the frequency corresponding to a frequency of an externally generated alternating magnetic field.

6. The device of claim 1, wherein one or more of the first conductive plate and the second conductive plate comprise a copper plate or a copper alloy plate.

7. The device of claim 1, wherein the electronic device comprises one of a watch or a fitness tracking device.

8. The device of claim 1, wherein the first conductive plate and the second conductive plate have a width between 20 mm and 50 mm.

9. The device of claim 1, wherein the first conductive plate and the second conductive plate have a length between 10 mm and 35 mm.

10. The device of claim 1, wherein the parallel plate capacitor formed by the first conductive plate and the second conductive plate is a series capacitor in the power receiving element.

11. The device of claim 1, wherein when the second band portion is attached to the first band portion, the first conductive plate and the second conductive plate are separated by a dielectric material.

12. The device of claim 11, wherein the dielectric material is rubber.

13. The device of claim 1, wherein when the second band portion is attached to the first band portion, the first conductive plate and the second conductive plate are separated by between 0.05 mm and 0.3 mm.

14. An electronic device comprising:
a first electrical connector disposed in a distal portion of a first band portion on the electronic device;
a second electrical connector disposed in a distal portion of a second band portion on the electronic device, the first band portion and the second band portion configured to be selectively attached to or detached from one another; and
a power receiving element which extends from the first electrical connector through the first band portion and the second band portion to the second electrical connector, wherein the first electrical connector and the second electrical connector are configured to be in electrical connection with each other when the first band portion and the second band portion are attached to one another, the power receiving element configured to wirelessly receive power from another device.

15. The device of claim 14, wherein the electronic device comprises one of a watch or a fitness tracking device.

16. The device of claim 14, wherein the first electrical connector and the second electrical connector are inductors, and wherein the electrical connection is an inductive connection.

17. The device of claim 14, wherein the first electrical connector and the second electrical connector are capacitive plates, and wherein the electrical connection is a capacitive connection.

18. The device of claim 17, wherein one or more of the first electrical connector and the second electrical connector comprise a copper plate or a copper alloy plate.

19. The device of claim 17, wherein the first electrical connector and the second electrical connector have a width between 20 mm and 50 mm.

20. The device of claim 17, wherein the first electrical connector and the second electrical connector have a length between 10 mm and 35 mm.

21. The device of claim 14, wherein when the second band portion is attached to the first band portion, the first electrical connector and the second electrical connector are separated by a dielectric material.

22. The device of claim 21, wherein the dielectric material is rubber.

23. The device of claim 14, wherein when the second band is attached to the first band portion, the first electrical connector and the second electrical connector are separated by between 0.05 mm and 0.3 mm.
